(19) United States
(12) Patent Application Publication
(10) Pub. No.: US 2023/0172387 A1
(43) Pub. Date: Jun. 8, 2023

(54) Coffee Capsule Treatment Tool

(71) Applicant: Wen-Ching Hsieh, New Taipei City (TW)

(72) Inventor: Wen-Ching Hsieh, New Taipei City (TW)

(21) Appl. No.: 17/740,752

(22) Filed: May 10, 2022

Related U.S. Application Data
(60) Provisional application No. 63/285,166, filed on Dec. 2, 2021.

(51) Int. Cl. A47J 31/40; A47G 21/04

(52) U.S. Cl. CPC A47J 31/407; A47G 21/04

(57) ABSTRACT

A coffee capsule treatment tool comprises a cutter part having a plated body and a dent formed inwardly at a center of the plated body. At least one cutter is protruded from a surface of the dent of the plated body with sharp tip. A spoon part is optionally connected or detachable from a side of the cutter part. The spoon part comprises a spoon at its tip is extended from a side of the plate body of the cutter part connected with a spoon handle. The present invention provides a handy hand tool for the user to easily separated the coffee capsule for recycling. The present invention can enhance or raise the intention of the user to recycle the coffee capsule properly to avoid of solve the environmental problem causing by the conventional coffee capsules.

### RELATED APPLICATION(S)

This application claims the benefit of U.S. provisional patent application with Ser. No. 63/285,166, filed on 2 Dec. 2021.

### FIELD OF INVENTION

The present invention generally relates to a tool, especially to a hand tool for treating a used coffee capsule containing a used or residual food or beverage ingredient.

### BACKGROUND OF THE INVENTION

In the past decades, more and more coffee lovers worldwide have adopted a new method of starting their daily jolt of caffeine with coffee capsules, in which a small aluminum container or aluminum pods capped with aluminum foil filled with high quality coffee grounds. Just simply putting into a compatible coffee machine, a cup of quickly with palatable coffee is good to go for starting a wonderful day.

Coffee capsules (also called coffee cartridges or coffee pods) market started with a Swiss company named “Nespresso”, which was launched in 1986 in the market. As time going, the variety of coffee capsules available is immense nowadays. Customers are spoilt for choice, and can enjoy basically any beverage from coffee, hot chocolate, flavored coffees to tea in such tiny capsule filled with joy and energy.

However, with the enormous selling quantities of coffee capsules, this product is attracting the concerns of environmental menace. The capsules can't be recycled easily with a mixture of aluminum container capped with aluminum foil cover and coffee ground residuals inside.

Although “Nespresso” provides a hill recycling system counting on the customers bringing back the coffee capsules directly back to a local store, it is still not practical to the customer as the convenience of the online shopping and this approach is considered causing even much more carbon footprints. Also, most of European cities don't accept recycling the aluminum container contained with coffee grounds residuals. Hence, to properly recycle this coffee capsules, the customer needs to firstly remove the aluminum foil cover which is tightly attached or sealed with the aluminum container, further to scrap out all the coffee grounds residuals inside and to recycle all these parts and materials in at least two different recycle categories. All these complicated recycling procedures make the customer unwilling to recycle the capsules properly but just simply throwing it into garbage and causing environmental problems.

Hence, it is eager to have a solution for recycling the coffee capsules more easily that will overcome or substantially ameliorate at least one or more of the deficiencies of a prior art, or to at least provide an alternative solution to the existing problems. It is to be understood that, if any prior art information is referred to herein, such reference does clot constitute an admission that the information forms part of the common general knowledge in the art.

### SUMMARY OF THE INVENTION

In order to solve the coffee capsules causing the environmental problems, the present invention provides a coffee capsule treatment tool to ease or at least provide a substituted solution.

In accordance with a first concept of the present invention, a coffee capsule treatment tool comprises: a cutter part and such cutter having a plated body and a dent formed inwardly at a center of the plated body; and at least one cutter is protruded from a surface of the dent of the plated body with sharp tip.

In accordance with a second concept of the present invention, a capsule treatment tool adapted to a capsule comprising a cutter part and a spoon part optionally connected or detachable from a side of the cutter part, wherein: a plated body and a dent formed inwardly at a center of the plated body; at least one cutter is protruded from a surface of the dent of the plated body with sharp tip; and the spoon part comprises a spoon at its tip is extended from a side of the plate body of the cutter part connected with a spoon handle.

In accordance, the present invention has the following advantages:

1. The present invention provides a coffee capsule treatment tool adapted to a coffee capsule which could easily cut and separate the aluminum foil cover from the capsule. The plated body of the present invention comprises a concaved dent with corresponding shape and dimension of the outer girth of the coffee capsule. the cutter(s) of the present invention will cut into the aluminum foil cover. As rotating the present invention along with the outer girth of the coffee capsule, the cutter(s) will cut the aluminum foil cover from the coffee capsule. Further by cleaning the coffee grounds residual from the aluminum container of the coffee capsule with or without the spoon part of the present invention, such coffee capsule could be separated as at least two different parts including the aluminum foil cover and container for metal recycling and the coffee grounds residual for organic waste recycling.

2. The present invention provides a handy hand tool for the user to easily separated the coffee capsule for recycling. The present invention can enhance or raise the intention of the user to recycle the coffee capsule properly so as to avoid of solve the environmental problem causing by the conventional coffee capsules and also reduce carbon footprints by such approach.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1A to FIG. 1C are some illustrated figures a first embodiment of the coffee capsule treatment tool in accordance with the present invention.

FIG. 2 is a bottom angel view of the first embodiment of the coffee capsule treatment tool in accordance with the present invention.

FIG. 3 is a illustrated figure of a second embodiment of the coffee capsule treatment tool in accordance with the present invention.

FIG. 4 is a illustrated flow chart of the first and second embodiment of the coffee capsule treatment tool in accordance with the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”. “have or having”, “contain or containing” and the like are to be understood to be open-ended, i.e., to mean including but not limited to.

The present invention is preferred to be applied to the used capsule of a brand “Nespresso” for separating a cover of such capsule and cleaning the coffee residual inside. However, the present invention is not intended to be limited to such certain or single usage. The capsules from other brands with similar design could. also be treated by the capsule treatment tool provided by the present invention.

### Embodiment 1

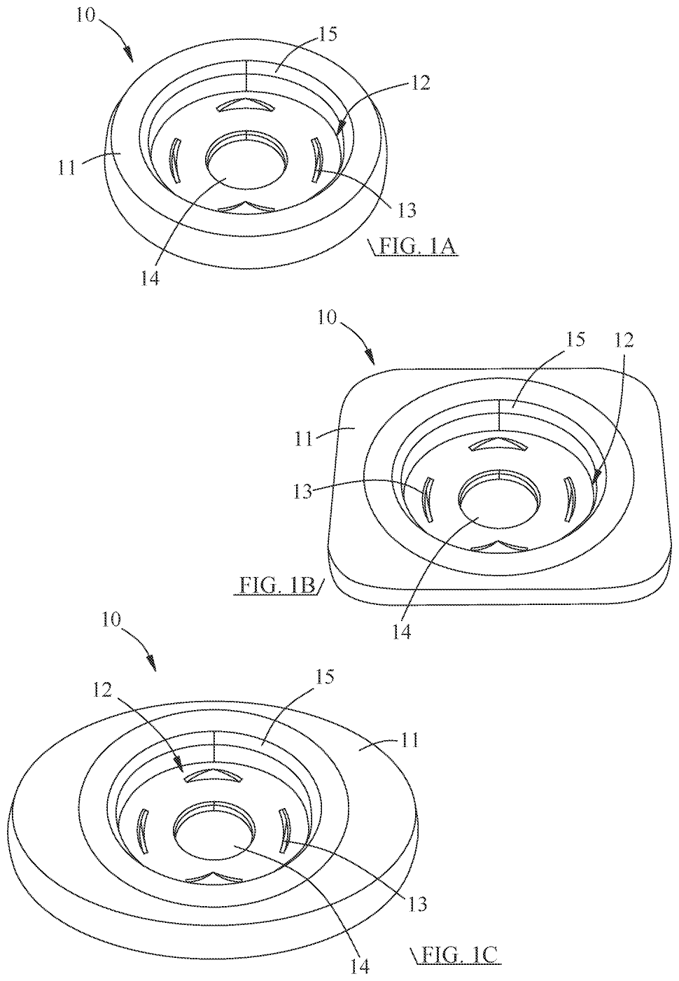

With reference to FIG. 1A to FIG. 1C, a first embodiment of the present invention, a coffee capsule treatment tool are presented. The said coffee capsule treatment tool comprises a cutter part 10 as shown in FIG. 1A. The cutter part 10 comprises a plated body 11 with a dent 12 formed inwardly at a center of the plated body 11. The dent 12 has a round dimension or round shape corresponded with a used coffee capsule, such as any Nespresso's used coffee capsule and especially to an outer girth of the said coffee capsule at its aluminum cover side. Under the consistency of the round dent 12 at the center of the plated body 11, such plated body 11 of the present invention could be any suitable shapes including round shape in FIG. 1A, rectangular shape in FIG. 11B or oval shape in FIG. 1C.

At least one cutter 13 is protruded from a surface of the dent 12 of the plated body 11. The cutter 13 in this preferred embodiment is a triangle blade with sharp tip protruded from the surface of the dent 12. Numbers of the cutter 13 arranged on the surface of the dent 12 could be multiple to have a better performance to the present invention. As for a preferred embodiment to the multiple cutter 13, as shown in FIG. 1A, four cutters 13 are aligned as a circle with equality 90 degree apart. The cutters 13 are preferred to be placed on the surface of the dent 12 and protected by the plated body 11 surrounding which provide a protection for the cutters 13 from damage or hurting user.

Yet another preferred embodiment of the present invention, at a center surface of the dent 12 of the plated body 11, a hole 14 could be further implemented. This design could further allow the cut aluminum cover of the capsule to be easily taken off from the dent 12 after being separated from the capsule.

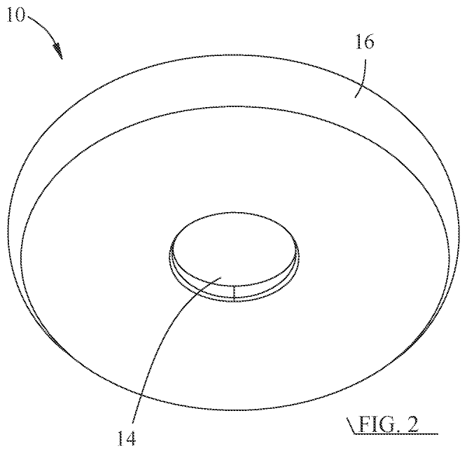

With reference to FIG. 1A, a ramp design 15 as shown in FIG. 2 could be further included at a edge of the dent 12 of the plated body 11 for allowing the capsule easier to slide inside the dent 12.

Further with reference to FIG. 2, an outer surface of the plated body 11 is preferred to have a round or smooth edge 16 for better holding experience to the user.

### Embodiment 2

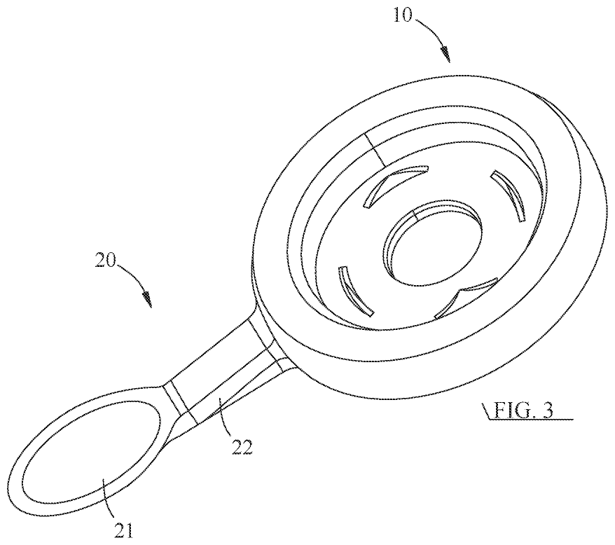

With reference to FIG. 3, in this embodiment, a spoon part 20 is optionally connected or detachable from a side of the cutter part 10 as described in the previous embodiment 1. The spoon part 20 comprises a spoon 21 at its tip is extended from a side of the plate body of the cutter part 10 connected with a spoon handle 22.

The preferred size of the spoon 21 is better to be smaller or slightly smaller to the size of the coffee capsule to be inserted more easily. The scraping part of the spoon 21 is also preferred to have its curve or curvature corresponded to the size of the capsule. The spoon handle 22 is preferred to have a gradual thickness from the connection of the plated body toward the scraping part of the spoon 21 as shown in FIG. 3 for enhancing the strength of the structure of the spoon connecting for the cutter part 10 and the spoon part 20.

<Usage of the Present Invention>

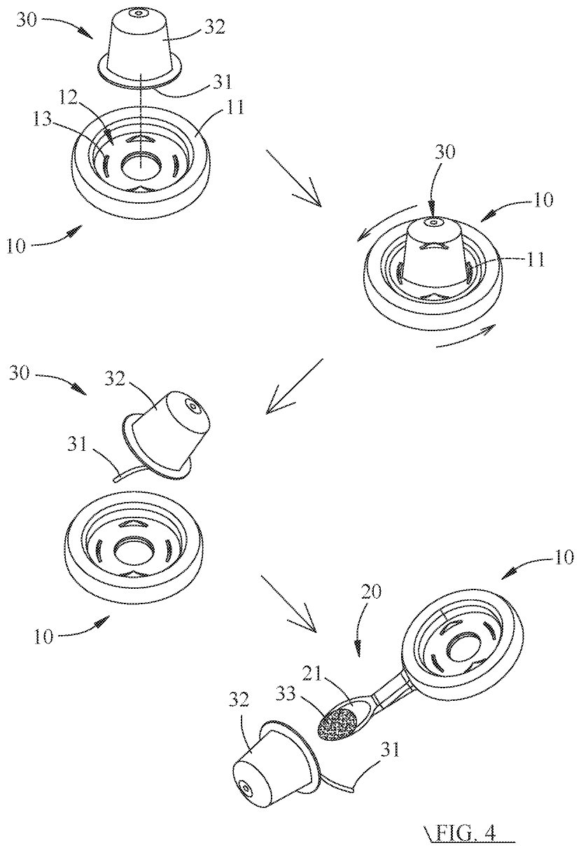

For the first embodiment as mentioned before and with reference to FIG. 4, the present invention is intended to apply to a coffee capsule 30 with a aluminum cover 31 capped with a aluminum container 32. Such coffee capsule 30 is usually a used capsule with coffee grounds residual 33 inside. As the used coffee capsule 30 being placed within the dent 12 of the plated body 11 with its outer girth at the aluminum cover 31, the cutters 13 are perfectly in placed or inserted into the coffee capsule 30. With slightly turning of the plated body 11 in a circle direction along the girth of the coffee capsule 30, like turning back and forth rotating with each 45 degree, the aluminum cover 31 of the coffee capsule 10 will be cut and detached from the coffee capsule 10 and the coffee grounds residual 33 will be exposed.

At this point, the user could just drop the coffee grounds residual out of from the aluminum container 32 to obtain separated the aluminum cover 31, the aluminum container 32 and the coffee grounds residual 33 for further recycling.

Optionally, the user could also implement the second embodiment provided by the present invention. The spoon 21 from the spoon part 20 is further to help scraping the coffee grounds residual 33 out of the coffee capsule 30. As the result, the metal (or the foil) part of the coffee capsule 30 could be successfully separated from the coffee grounds residual 33 for further recycling.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A capsule treatment tool adapted to a capsule comprising a cutter part, wherein the cutter part comprises:
a plated body and a dent formed inwardly at a center of the plated body; and
at least one cutter is protruded from a surface of the dent of the plated body with sharp tip.

2. A capsule treatment tool adapted to a capsule comprising a cutter part and a spoon part optionally connected or detachable from a side of the cutter part, wherein:
a plated body and a dent formed inwardly at a center of the plated body;
at least one cutter is protruded from a surface of the dent of the plated body with sharp tip; and
the spoon part comprises a spoon at its tip is extended from a side of the plate body of the cutter part connected with a spoon handle.

3. The tool as claimed in claim 1, wherein: the dent comprises a round dimension or round shape corresponded with a used capsule.

4. The tool as claimed in claim 2, wherein: the dent comprises a round dimension or round shape corresponded with a used capsule.

5. The tool as claimed in claim 3, wherein: under the consistency of the round dent at the center of the plated body, a shape of the plated body includes round shape, rectangular shape, or oval shape.

6. The tool as claimed in claim 4, wherein: under the consistency of the round dent at the center of the plated body, a shape of the plated body includes round shape, rectangular shape, or oval shape.

7. The tool as claimed in claim 1, wherein: multiple cutters are aligned on the surface of the dent.

8. The tool as claimed in claim 2, wherein: multiple cutters are aligned on the surface of the dent.

9. The tool as claimed in claim 7, wherein four cutters are aligned as a circle with equality 90 degree apart on the surface of the dent.

10. The tool as claimed in claim 8, wherein four cutters are aligned as a circle with equality 90 degree apart on the surface of the dent.

11. The tool as claimed in claim 9, wherein: each cutter is a triangle blade with sharp tip protruded from the surface of the dent.

12. The tool as claimed in claim 10, wherein: each cutter is a triangle blade with sharp tip protruded from the surface of the dent.

13. The tool as claimed in claim 1, wherein: a hole is formed at a center surface of the dent of the plated body.

14. The tool as claimed in claim 2, wherein: a hole is formed at a center surface of the dent of the plated body.

15. The tool as claimed in claim 1, wherein: a ramp design is included at a edge of the dent of the plated body.

16. The tool as claimed in claim 2, wherein: a ramp design is included at a edge of the dent of the plated body.

17. The tool as claimed in claim 1, wherein: an outer surface of the plated body has a round or smooth edge.

18. The tool as claimed in claim 2, wherein: an outer surface of the plated body has a round or smooth edge.

19. The tool as claimed in claim 2, wherein: the spoon handle has a gradual thickness from a connection of the plated body toward the scraping part of the spoon.
